(19) United States
(12) Patent Application Publication
(10) Pub. No.: US 2023/0076870 A1
(43) Pub. Date: Mar. 9, 2023

(54) PROTECTIONS FOR SENSITIVE CONTENT ITEMS IN A CONTENT MANAGEMENT SYSTEM

(71) Applicant: Dropbox, Inc., San Francisco, CA (US)

(72) Inventors: Hudson Arnold, Alameda, CA (US); Chelsi Cocking, Brooklyn, NY (US); David Lichtenberg, San Francisco, CA (US); William Formyduval, Horseheads, NY (US); Panashe Fundira, Brooklyn, NY (US)

(21) Appl. No.: 17/466,830

(22) Filed: Sep. 3, 2021

(51) Int. Cl. G06F 21/62; G06F 9/451

(52) U.S. Cl. CPC G06F 21/6245; G06F 9/451

(57) ABSTRACT

Techniques are disclosed for protecting a user of a content management system from inadvertently or accidentally disclosing sensitive information contained in a content item hosted with the system. In response to receiving a request by the user to perform a sensitive information exposing action on the sensitive content item, the content management system performs a sensitive information protective action for the sensitive content item. By doing so, the techniques improve the operation of the content management system through increased information security.

### TECHNICAL FIELD

The present disclosure relates to techniques for protecting a user of a content management system from inadvertently or accidentally disclosing sensitive information contained in a content item hosted with the system.

### BACKGROUND

Use of a content management system is an increasingly popular way to store, share, and collaborate on a content item. The content item might be a digital file, photo, or video that a user uploads to the content management system from a personal computing device. Or the content item could instead be a “cloud” document that is “hosted” by the content management service, and which is accessed by a user over a data communications network from a personal computing device. The content item might also be a collection or “folder” of other content items.

Whether an uploaded file, a cloud document, or a folder, a content item may be sensitive. A sensitive content item is a content item that contains sensitive information. Sensitive information is information for which unauthorized access or unwarranted disclosure could adversely affect the interests of a person or organization. Examples of sensitive information include sensitive personally identifiable information (PII) and sensitive organizational information.

Sensitive PII includes information that permits the identity of an individual to be directly or indirectly inferred and that, if disclosed, could result in harm to the individual whose identity is linked or linkable to the information. For example, knowing a person's social security number and mother's maiden name can make it easier for a fraudster to apply for a credit card in the person's name. Other examples of PII include a person's bank account number, bank routing number, credit card number, credit card security code, credit card expiration, bank card PIN code, name, address, phone, email, age, date of birth, username, password, Internet Protocol (IP) address, Media Access Control (MAC) address, and driver's license number.

Sensitive organizational information includes information that would pose a risk to an organization if obtained by a competitor or the public. For example, an organization's confidential intellectual property information, trade secrets, or company merger plans could all be harmful to the organization if it fell into a rival's or the public's hands.

A useful feature of content management systems is the ability to share a content item between users. Sharing a content item using a content management system generally involves a user using the system to grant access to the content item to another user of the system. The user that grants the access is sometime referred to as the “sharing” user with respect to the content item. The other user that is granted the access to the content item by the sharing user is sometimes referred to as the “invited” user with respect to the content item.

To protect sensitive information in a sensitive content item that is shared between users, a content management system may use encryption to cryptographically encrypt the contents of the sensitive content item. Encryption is useful to prevent a user who is not an invited user from accessing the sensitive information contained in the content item. However, content encryption will not prevent the invited user from accessing the sensitive information. Instead, to provide the invited user the granted access, the content management system decrypts the content item so that the invited user can access the content item including the sensitive information in the content item in an unencrypted form. Thus, content encryption is not sufficient to protect the sensitive information in the shared content item where the sharing user inadvertently or accidentally shares the sensitive content item with an invited user that should not have access to the sensitive information.

The present disclosure addresses this and other issues.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

The disclosed techniques for protecting a user of a content management system from inadvertently or accidentally disclosing sensitive information contained in a content item hosted with the system encompass a method implementation, a non-transitory storage medium implementation, and a computing system implementation.

In an implementation of the disclosed techniques, a method for protecting a user of a content management system from inadvertently or accidentally disclosing sensitive information contained in a content item hosted with the system is performed by a computing system. The computing system comprises one or more hardware processors, storage media, and instructions configured to perform the method and executed by the one or more hardware process to perform the method. The performance of the method by the computing system includes determining that a content item in the content management system is sensitive, based on content of the content item. The method further includes the computing system receiving a request by a user of the content management system to use the content management system to perform a sensitive information exposing action on the content item. The method also includes the computing system performing a sensitive information protective action for the content item based on receiving the user request.

In an implementation of the disclosed techniques, the method further includes classifying the content item as a particular type of sensitive content item based on content of the content item and determining to perform the sensitive information protective action for the content item based on the content item being the particular type of sensitive content item.

In an implementation of the disclosed techniques, the method further includes detecting a particular type of sensitive information item contained in the content item based on content of the content item and determining to perform the sensitive information protective action for the content item based on the content item containing the particular type of sensitive information item.

In an implementation of the disclosed techniques, the method further includes classifying the content item as a particular type of sensitive content item based on content of the content item, detecting a particular type of sensitive information item contained in the content item based on content of the content item, and determining to perform the sensitive information protective action for the content item based on the content item being the particular type of sensitive content item and based on the content item containing the particular type of sensitive information item.

In an implementation of the disclosed techniques, a non-transitory storage medium stores computer program instructions for protecting a user of a content management system from inadvertently or accidentally disclosing sensitive information contained in a content item hosted with the system. The computer program instructions, when executed by a computing system, cause the computing system to perform any of the foregoing methods.

In an implementation of the disclosed techniques, a computing system comprises one or more hardware processors, storage media, and computer program instructions for protecting a user of a content management system from inadvertently or accidentally disclosing sensitive information contained in a content item hosted with the system. The computer program instructions are stored in the storage media and are configured for execution by the one or more hardware processors. The computer program instructions, when executed by the one or more hardware processors, cause the computing system to perform any of the foregoing methods.

These and other implementations of the disclosed techniques, as well as the disclosed techniques generally, are described in greater detail below with reference to drawings.

### BRIEF DESCRIPTION OF THE DRAWINGS

In the drawings:

FIG. 1 depicts a content management system, in accordance with one or more example implementations.

FIG. 2 is a mock-up of a possible graphical user interface for allowing a user to opt-in to protections for sensitive content items in the content management system, in accordance with one or more example implementations.

FIG. 3 is a mock-up of a possible graphical user interface for allowing a user to select which types of the user's content items hosted with the content management system receive protections for sensitive content items in the content management system, in accordance with one or more example implementations.

FIG. 4 is a mock-up of a possible graphical user interface for allowing a user to select which types of sensitive information items contained in a user's content items hosted with the content management system receive protections for sensitive content items in the content management system, in accordance with one or more example implementations.

FIG. 5 is a flowchart of a process for protecting a user of the content management system from inadvertently or accidentally disclosing sensitive information contained in a content item hosted with the system, in accordance with one or more example implementations.

FIG. 6 is a mock-up of a possible graphical user interface allowing a user to request the content management system to perform a sensitive information exposing action on a sensitive content item, in accordance with one or more example implementations.

FIG. 7 is a mock-up of a possible graphical user interface allowing a user to request the content management system to perform a sensitive information exposing action on a sensitive content item, in accordance with one or more example implementations.

FIG. 8 is a mock-up of a possible graphical user interface depicting a sensitive information protective action performed by the content management system for a sensitive content item, in accordance with one or more example implementations.

FIG. 9 is a mock-up of a possible graphical user interface depicting a sensitive information protective action performed by the content management system for a sensitive content item, in accordance with one or more example implementations.

FIG. 10 is a mock-up of a possible graphical user interface depicting a sensitive information protective action performed by the content management system for a sensitive content item, in accordance with one or more example implementations.

FIG. 11 is a mock-up of a possible graphical user interface depicting a sensitive information protective action performed by the content management system for a sensitive content item, in accordance with one or more example implementations.

FIG. 12 is a mock-up of a possible graphical user interface depicting a sensitive information protective action performed by the content management system for a sensitive content item, in accordance with one or more example implementations.

FIG. 13 is a mock-up of a possible graphical user interface depicting a sensitive information protective action performed by the content management system for a sensitive content item, in accordance with one or more example implementations.

FIG. 14 is a mock-up of a possible graphical user interface depicting a sensitive information protective action performed by the content management system for a sensitive content item, in accordance with one or more example implementations.

FIG. 15 is a schematic of a basic computing device that may be used in an implementation of the disclosed techniques, in accordance with one or more example implementations.

### DETAILED DESCRIPTION

In the following description, for the purposes of explanation, numerous specific details are set forth to provide a thorough understanding of the disclosed techniques. It will be apparent, however, that the disclosed techniques may be practiced without these specific details. In other instances, well-known structures and devices are shown in block diagram form to avoid unnecessarily obscuring the disclosed techniques.

### General Overview

Techniques are disclosed for protecting a user of a content management system from inadvertently or accidentally disclosing sensitive information contained in a content item hosted with the system. In response to (e.g., as a but-for cause of) receiving a request by the user to perform a sensitive information exposing action on the sensitive content item, the content management system performs a sensitive information protective action for the sensitive content item. By doing so, the techniques improve the operation of the content management system through increased information security.

The sensitive information exposing action may be any action that may potentially expose sensitive information. The sensitive information protective action may be any action that may protect sensitive information from being shared. For example, the sensitive information exposing action may be the user sharing the sensitive content item, and the sensitive information protective action may be the content management system requesting the sharing user to confirm sharing of the sensitive content item before the sensitive content item is shared. The request to confirm sharing may indicate to the sharing user that the content item is sensitive. For example, in response to the sharing user requesting the content management system to share the sensitive content item with an intended invited user, the content management system may prompt the sharing user in a computer graphical user interface to confirm sharing of the sensitive content item. The graphical user interface prompt may warn the sharing user that the content item contains sensitive information. By doing so, the sharing user may be made aware that the content item is sensitive before inadvertently or accidentally sharing the sensitive content item with the intended invited user.

The sensitive information protective action may be the content management system notifying the sharing user that the sensitive content item contains sensitive information. For example, in response to the sharing user requesting the content management system to share the sensitive content item with the intended invited user, the content management system may share the sensitive content item with the intended invited user without a prior prompting of the sharing user to confirm the sharing of the sensitive content item. Nonetheless, the content management system may notify the sharing user that the content item contains sensitive information. For example, the content management system may notify the sharing user in an email message, a text message, or in a computer graphical user interface in response to the request from the sharing user to share the sensitive content item. By doing so, the sharing user is not burdened with having to confirm the sharing request but nonetheless the sharing user is notified that the content item contains sensitive information in case the sharing user inadvertently or accidently shared the sensitive content item. In that case, the sharing user can request to the content management system to un-share the sensitive content item.

The content management system may perform the sensitive information protective action for the sensitive content item only if the sharing user has opted-in to protections against the sharing user from inadvertently or accidentally disclosing sensitive information contained in a content item hosted with the system. For example, the content management system may provide a computer graphical user interface whereby the sharing user can select an option to enable or disable protections against the sharing user from inadvertently or accidentally disclosing sensitive information contained in a content item hosted with the system. In this case, the sensitive information protective action is not performed for the sensitive content item unless the option is enabled.

The sharing user may request the content management system to share the sensitive content item by a unique link to the sensitive content item. The unique link may be a unique Uniform Resource Locator (URL) or other type of unique link for accessing the content item from the content management system. The sensitive information protective action for the sensitive content item may be the content management system expiring the unique link after the expiration of a timer such that the sensitive content item can no longer be accessed from the content management system after the unique link is expired. For example, the content management system may set the unique link to expire forty-eight hours after the sensitive content item is shared by the sharing user. By doing so, the risk that sensitive information in the sensitive content item is accessed or used in a manner that is not intended by the sharing user is reduced because the sensitive content item is not accessible at the unique link longer than reasonably necessary for the invited user to use the unique link and access the sensitive content item as intended by the sharing user.

The sensitive information protective action may be the content management system prompting the sharing user to protect access to the sensitive content item with a passcode or pin code. In this case, when the invited user attempts to access the sensitive content item from the content management system, the invited user is prompted to provide the sharing user-provided passcode or pin code before the content management system provides the requested access to the sensitive content item. By doing so, the risk that the sensitive content item is accessed by a user not in possession of the passcode or pin code is reduced. For example, a user that can access the invited user's account with the content management system (e.g., the user has stolen login credentials from or shares login credentials with the invited user) cannot practically access the sensitive content item without the passcode or pin code.

The sensitive information protective action may be the content management system prompting the sharing user to encrypt the contents of the sensitive content item using a key provided by the sharing user. In this case, when the invited user attempts to access the sensitive content item, the invited user is prompted to provide the sharing user-provided key to decrypt the content of the sensitive content item. By doing so, the risk that the sensitive content item is accessed by a user in possession of the encrypted sensitive content item but not in possession of the key is reduced.

The sensitive information protective action may be based on the “outbound” sharing history of the sharing user. For example, if, according to the outbound sharing history of the sharing user, the sharing user has never shared the type of the sensitive content item with the invited user, then the content management system may prompt the sharing user to confirm the sharing request to reduce the risk that the sharing user inadvertently or accidentally shares the sensitive content item with a user that the sensitive content item should not be shared with.

The sensitive information protective action may be based on the “inbound” sharing history of the invited user. For example, if, according to the inbound sharing history of the invited user, the type of the sensitive content item is never or rarely shared with the invited user by users of the content management system, then the content management system may prompt the sharing user to confirm the sharing request to reduce the risk that the sharing user inadvertently or accidentally shares the sensitive content item with a user that the sensitive content item should not be shared with.

A content management system provides a digital repository/interface used to store, share, and collaborate on content items. Use of such a digital repository gives rise to the risk of unintended exposure of sensitive information because using these systems allows non-owner users to access digital copies of content items with sensitive information. Specifically, the ease with which content management system technology allows for sharing of information can create data vulnerabilities for users. Content management system technology requires sensitive information protection that both allows sharing of information (utilizing the content management system technology) and protection of sensitive information from unintended exposure to non-owners.

Automatically identifying sensitive information within a content management system based on the content of a content item allows the content management system to automatically determine which content items potentially require protection. This automatic identification of sensitive information allows protective action to automatically be taken in response to receiving a request from a user to perform a sensitive information exposing action on a target content item, without requiring a user to recognize when sensitive information is included in the target content item. Thus, the content sharing technology of the content management system may be utilized without causing unintended exposure of sensitive information to non-owners.

### Example Content Management System

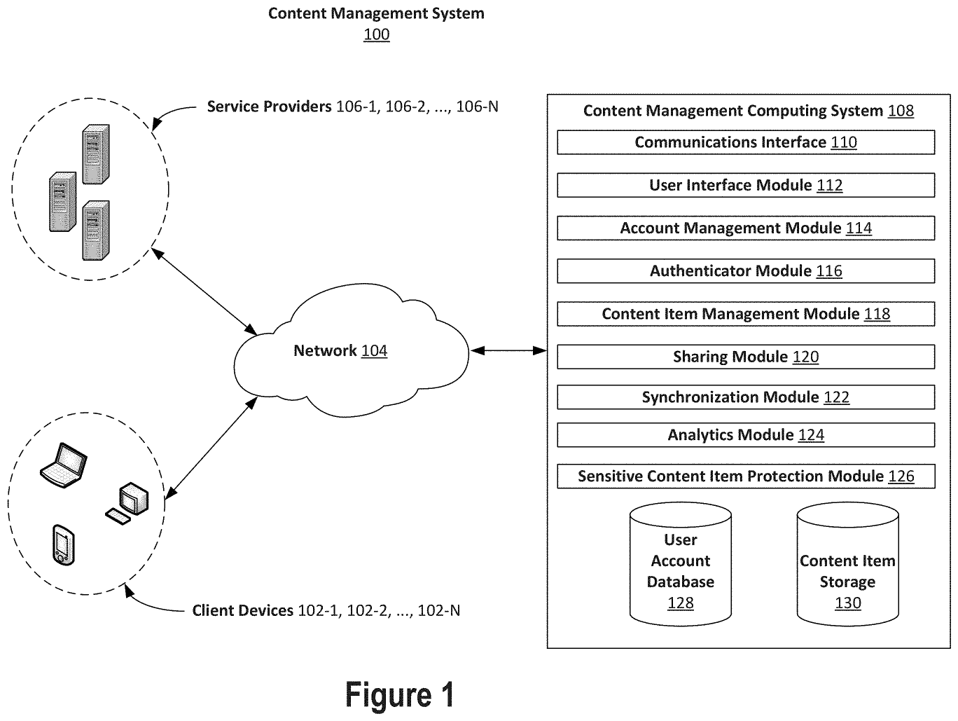

With respect to implementing various embodiments of the disclosed technology, example content management system 100 is shown in FIG. 1, wherein electronic devices communicate via a network for purposes of exchanging content and other data. System 100 can be configured for use on data communications network 104. Data communications network 104 can be the Internet or other wide-area data communications network, for example. However, the disclosed techniques can be implemented in a variety of network configurations that facilitate the intercommunication of electronic devices via a wired or wireless data communications network. For example, while data communications network 104 can be the Internet where content management computing system 108 is implemented as a “cloud” computing service, data communications network 104 can be a local wireless area network or other type of local area network within a home or office, for example, where content management computing system 108 is a computing appliance within the home or office. Although not shown in FIG. 1, a client device 102 may communicate with content management computing system 108 via a different data communications network than a service provider 106. For example, a client device 102 may communicate with content management computing system 108 via a local area network and a service provider 106 may communicate with content management computing system 108 via the Internet.

In system 100, a user can interact with content management computing system 108 through a client device 102 connected to network 104. Content management computing system 108 can be implemented with a single computing device (e.g., a server) or with multiple computing devices (e.g., multiple servers) that are configured to perform the functions or operations described herein. Content management computing system 108 can support connections from a variety of different types of client device, including, but not limited to, a desktop computer, a mobile computer, a mobile communications device, a mobile phone, a smart phone, a tablet computer, a smart television, a set-top box, or any other data communications network-enabled computing device. A client device 102 can be of varying type and capability and be configured with a varying type of operating system (e.g., a UNIX-based or a WINDOWS-based operating system). Furthermore, content management system 108 can concurrently accept network connections from and concurrently interact with multiple client devices 102.

A user can interact with content management computing system 108 via a client-side application installed on a client device 102. The client-side application can include a content management system specific component. For example, the component can be a stand-alone application, one or more application plug-ins, or a web browser extension. However, the user can also interact with content management computing system 108 via a third-party application, such as a web browser, that is installed and executes on the client device 102 and is configured to communicate with content management system 108. In either case, the client-side application can present a graphical user interface (GUI) for the user to interact with content management computing system 108. For example, the user can interact with the content management system 108 via a client-side application integrated with the file system or via a webpage displayed using a web browser application.

Content management computing system 108 can enable a user to store content items, including sensitive content items, as well as perform a variety of content management tasks, such as retrieve, modify, browse, or share the content items. Furthermore, content management computing system 108 can enable a user to access content items from multiple client devices 102. For example, a client device 102 can upload a content item to content management computing system 108 via network 104. Later, the same client device 102 or some other client device 102 can retrieve the content item from content management computing system 108.

To facilitate the various content management services, a user can create an account with content management computing system 108. User account database 128 can maintain the account information. User account database 128 can store profile information for a registered user. For example, the profile information may include a username or email address for the registered user. However, content management computing system 108 can also be configured to accept additional user information such as birthday, address, billing information, etc.

User account database 128 can include account management information, such as account type (e.g., free or paid), usage information, (e.g., content item viewing, editing, and sharing history), maximum content item storage space authorized, content item storage space used, content item storage locations, security settings, personal configuration settings, content item sharing data, etc. Account management module 114 can be configured to update or obtain user account details in user account database 128. The account management module 114 can be configured to interact with any number of other modules in content management computing system 108.

An account can be used to store content items, such as digital data, documents, text files, audio files, video files, cloud documents, etc., from one or more client devices 102 authorized on the account. The content items can also include collections for grouping content items together with different behaviors, such as folders, playlists, albums, etc. For example, an account can include a public folder that is accessible to any user. The public folder can be assigned a web-accessible address. A unique link (e.g., a unique Uniform Resource Locator (URL)) to the web-accessible address can be used to access the contents of the public folder. In another example, an account can include: a photos collection that is intended for photos and that provides specific attributes and actions tailored for photos; an audio collection that provides the ability to play back audio files and perform other audio related actions; or other special purpose collection. An account can also include shared collections or group collections that are linked with and available to multiple user accounts. The permissions for multiple users may be different for a shared collection.

The content items can be stored in content item storage 130. Content item storage 130 can be a storage device, multiple storage devices, or a server. Alternatively, content item storage 130 can be a cloud storage provider or network storage accessible via a data communications network. Content management computing system 108 can hide the complexity and details from client devices 102 so that client devices 102 do not need to know exactly where or how the content items are being stored by content management computing system 108. For example, content management computing system 108 can store the content items in the same collection hierarchy as they appear on a client device 102. However, content management computing system 108 can store the content items in its own order, arrangement, or hierarchy. Content management computing system 108 can store the content items in a network accessible storage (NAS) device, in a redundant array of independent disks (RAID), etc. Content item storage 130 can store content items using one or more partition types, such as FAT, FAT32, NTFS, EXT2, EXT3, EXT4, HFS/HFS+, BTRFS, and so forth.

Content item storage 130 can also store metadata describing content items, content item types, and the relationship of content items to various accounts, collections, or groups. The metadata for a content item can be stored as part of the content item or can be stored separately. In an implementation, each content item stored in content storage 130 may be assigned a system-wide unique identifier.

Content item storage 130 can decrease the amount of storage space required by identifying duplicate content items or duplicate segments or blocks of content items. Instead of storing multiple copies of the duplicate content items, segments, or blocks, content item storage 130 can store a single copy and then use a pointer or other mechanism to link the duplicates to the single copy. Similarly, content item storage 130 can store content items more efficiently, as well as provide the ability to undo operations, by using a content item version control that tracks changes to content items, different versions of content items (including diverging version trees), and a change history. The change history can include a set of changes that, when applied to the original content item version, produce the changed content item version.

Content management computing system 130 can be configured to support automatic synchronization of content items from a client device 102. The synchronization can be platform agnostic. That is, the content items can be synchronized with a client device 102 without requiring a particular type, capability, or operating system of the client device 102. For example, a client device 102 can include client software, which synchronizes, via synchronization module 122 at content management computing system 108, content items stored in at a client device 102's file system with the content items in an associated user account. In some cases, the client software can synchronize any changes to content items in a designated collection and its sub-collections, such as new, deleted, modified, copied, or moved content items or collections. The client software can be a separate software application, can integrate with an existing content management application in the operating system, or some combination thereof. In one example of client software that integrates with an existing content management application, a user can manipulate content items directly in a local collection, while a background process monitors the local collection for changes and synchronizes those changes to content management computing system 108. Conversely, the background process can identify content items that have been updated at content management computing system 108 and synchronize those changes to the local collection. The client software can provide notifications of synchronization operations and can provide indications of content statuses directly within the content management application. Sometimes a client device 102 may not have a network connection available. In this scenario, the client software can monitor the linked collection for content item changes and queue those changes for later synchronization to content management computing system 108 when a network connection is available. Similarly, a user can manually start, stop, pause, or resume synchronization with content management computing system 108.

A user can view or manipulate a content item via a web interface generated and served by user interface module 112. For example, the user can navigate in a web browser to a web address provided by content management computing system 108. Changes or updates to the content item in the content item storage 130 made through the web interface, such as uploading a new version of the content item, can be propagated back to another client device 102 associated with the user's account. For example, multiple client devices 102, each with their own client software, can be associated with a single account and content items in the account can be synchronized between each of the multiple client devices 102.

Content management computing system 108 can include a communications interface 110 for interfacing with a client device 102 and can interact with a service provider 109 via an Application Program Interface (API). Certain software applications can access content item storage 130 via an API on behalf of a user. For example, a software package, such as an app running on a smartphone or tablet computing device, can programmatically make calls directly to content management computing system 108, when a user provides credentials, to read, write, create, delete, share, or otherwise manipulate a content item. Similarly, the API can allow a user to access all or part of content item storage 130 through a web site.

Content management computing system 108 can also include authenticator module 116, which can verify user credentials (e.g., a username and password), a security token, an API call, a client device, and so forth, to ensure only an authorized client and user can access a content item. In an implementation, authenticator module 116 authorizes a user to interact with content management computing system 108 based on user credentials the user keeps with a service provider 109 without the user having to provide the user credentials to content management computing system 108 using an industry-standard delegated authorization framework such as Open ID Connect (OIDC), OAuth 2.0, or the like.

Content management computing system 108 can include analytics module 124 module that can track and report on aggregate file operations, user actions, network usage, total content item storage space used, as well as other technology, usage, or business metrics. A privacy or security policy can prevent unauthorized access to user data stored with content management computing system 108.

Content management computing system 108 can include sharing module 120 for managing sharing a content item publicly or privately. Sharing content publicly can include making the content item accessible from any computing device in network communication with content management computing system 108. Sharing content privately can include linking the content item in content item storage 130 with two or more user accounts so that each user account has access to the content item. The sharing of the content item can be performed in a platform agnostic manner. That is, the content item can be shared with a client device 102 with requiring the client device 102 to be a particular type, to have a particular capability, or be configured with a particular operating system. The content item can also be shared across varying types of user accounts including individual, personal, group, or team accounts.

Content management computing system 108 can be configured to maintain a content item directory identifying a location of each content item in content item storage 130. The content item directory can include a unique content item entry for each content item stored in content item storage 130. A content item entry can include a content item path that can be used to identify a location of a content item in content item storage 130 or at a client device 102. For example, the content path can include the name of the content item and a folder hierarchy associated with the content item. For example, the content item path can include a folder or path of folders in which the content item is placed as well as the name of the content item. Content management computing system 108 can use the content item path to present the content item in the appropriate folder hierarchy. A content item entry can also include a content item pointer that identifies a location of the content item in content item storage 130. For example, the content pointer can include a storage address of the content item in non-transitory computer-readable media. The content item pointer can point to multiple locations in content item storage 130, each of which contains a portion (e.g., a block or segment) of the content item.

In addition to a content item path and a content item pointer, a content item entry can also include a user account identifier that identifies the user account that has access to the content item. Multiple user account identifiers can be associated with a single content item entry indicating that the content item has shared access by the multiple user accounts.

To share a content item privately, sharing module 120 can be configured to add a user account identifier to the content item entry associated with the content item, thus granting the added user account access to the content item. Sharing module 120 can also be configured to remove user account identifiers from a content item entry to restrict a user account's access to the content item. The user account identifier in a content item entry may also be associated with an access permission indicating a type of access that the user account has to the corresponding content item. A content item entry may contain multiple different access permissions associated with a user account identifier depending on the access permissions the user account is granted with respect to the content item. Non-limiting examples of access permissions that may be associated with a user account identifier in a content item entry include view, edit, delete, share, download, etc.

To share content publicly, sharing module 120 can be configured to generate a unique link, such as a unique uniform resource locator (URL), which allows a web browser or other client application to access the content item in content management computing system 108 without an authentication. To accomplish this, sharing module 120 can be configured to include content item identification data in the generated unique link, which can later be used to properly identify and return the requested content item. For example, sharing module 120 can be configured to include the user account identifier and the content path in the generated unique link. Upon selection of the unique link, the content item identification data included in the unique link can be transmitted to content management computing system 108 which can use the received content item identification data to identify the appropriate content item entry and return the content item associated with the content item entry.

In addition to generating the unique link, sharing module 120 can also be configured to record that unique link to the content item has been created. The content item entry associated with a content item can include a unique link flag indicating whether a unique link to the content item has been created. For example, the unique link flag can be a Boolean value initially set to 0 or false to indicate that a unique link to the content item has not been created. Sharing module 120 can be configured to change the value of the flag to 1 or true after generating a unique link to the content item.

Sharing module 120 can also be configured to deactivate a generated unique link. For example, each content item entry can also include a unique link active flag indicating whether the content item should be returned in response to a request from the generated unique link. For example, sharing module 120 can be configured to only return a content item requested by a generated link if the unique link active flag is set to 1 or true. Thus, access to a content item for which a unique link has been generated can be easily restricted by changing the value of the unique link active flag. This allows a user to restrict access to the shared content item without having to move the content item or delete the generated unique link. Likewise, sharing module 120 can reactivate the unique link by again changing the value of the unique link active flag to 1 or true. A user can thus easily restore access to the content item without the need to generate a new unique link.

While content management computing system 108 is presented with specific components, it should be understood by one skilled in the art, that the architectural configuration of system 108 is simply one possible configuration and that other configurations with more or fewer components are possible.

Content management system 108 includes sensitive content item protection module 126 for protecting sensitive content items stored in content item storage 130. Sensitive content item protection module 126, in combination with other module(s) of system 108, is configured to protect sensitive content items stored in content item storage 130 according to the disclosed techniques. For example, module 126 may be encompass computer program instructions configured to perform a method disclosed herein for protecting a user of content management computing system 108 from inadvertently or accidentally disclosing sensitive information contained in a content item hosted with the system 108 and executed by system 108 to perform the method.

Reference herein to “hosting” a content item with content management computing system 108 encompasses a user using content management computing system 108 to bring the content item under management of system 108. For example, a content item that a user hosts with system 108 may be one that the user uploads, synchronizes, or otherwise provides to system 108. When a content item is hosted with system 108, a digital copy or digital representation of the content item is stored in content item storage 130 either as a file, a set of one or more blocks or segments, or in other suitable data storage form.

### User Opt-In Examples

A user may host many content items with content management computing system 108. Not all the content items the user hosts with content management computing system 108 may be sensitive content items. Further, for personal reasons, the user may not want system 108 to protect against inadvertently or accidentally disclosing sensitive information contained in a content item that the user hosts with the system 108. Accordingly, in an implementation, sensitive content item protection module 126, in combination with user interface module 112, may allow the user to selectively opt-in to protection of sensitive content items the user hosts with system 108.

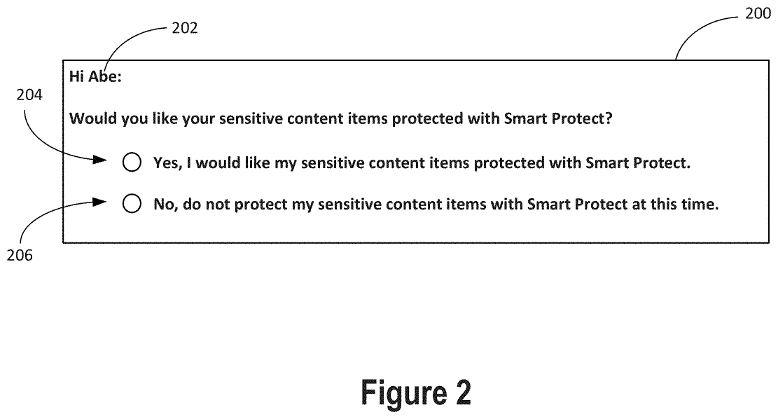

FIG. 2 is a mock-up of possible graphical user interface 200 for allowing a user of system 108 to opt-in to sensitive content item protections. User interface module 112 may cause interface 200 to be presented at a client device 102 of the user in conjunction with a client application executing at the client device 102 such as a web browser application or other client application. Interface 200 identifies 202 the user and prompts the user as to whether the user would like system 108 to protect the user's sensitive content items hosted with system 108 with a “Smart Protect” feature of system 108. Implementation of the Smart Protect feature by system 108, including by sensitive content item protection module 126, may encompass performance or application of techniques disclosed herein for protecting the user from inadvertently or accidentally disclosing sensitive information contained in a content item the user hosts with system 108. If the user selects option 204, then the user opts-in to the Smart Protect feature and system 108, as a result of the selection, is configured to apply techniques disclosed herein for protecting the user from inadvertently or accidentally disclosing sensitive information contained in a content item the user hosts with system 108. Alternatively, if the user selects option 206, then the user opts-out of the Smart Protect feature, and system 108, as a result of the selection, is configured to not apply the techniques to a content item that user hosts with system 108. The user may return to interface 200 later after an initial selection of one of the options 204 or 206 to select the other of the options 204 or 206. For example, the user may initially select option 204 and later decide after using system 108 for a period of time (e.g., days or weeks) to opt-out of the Smart Protect feature. In that case, the user may then return to interface 200 and select option 206. Thereafter, the Smart Protect feature will no longer be applied to the sensitive content items the user hosts with system 108 until the user again returns to interface 200 and selects option 204 at which point system 108 will then apply the Smart Protect feature again to the user's sensitive content items hosted with system 108.

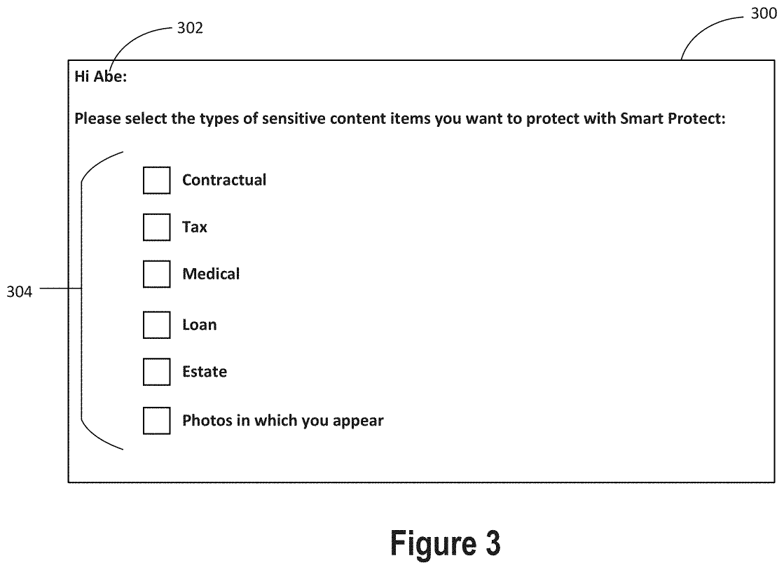

A user may host different types of sensitive content items with system 108. For example, among the sensitive content items that a user hosts with system 108, there might be contractual documents, tax documents, medical records, loan documents, estate documents, and digital photos in which the user appears. FIG. 3 is a mock-up of a possible graphical user interface 300 that allows a user of content management computing system 108 to select which types of sensitive content items that the user hosts with system 108 will receive protections for sensitive content items. User interface module 112 may cause interface 300 to be presented at a client device 102 of the user in conjunction with a client application executing at the client device 102 such as a web browser application or other client application. Interface 300 provides an identity 302 of the user. In this example, selectable types 304 of sensitive content items include contractual content items, tax content items, medical content items, loan content items, estate content items (e.g., wills and trust documents), and photos in which the user appears. The user may select one or more of types 304 to configure system 108 to apply protections to those selected types of sensitive content items that the user hosts with system 108. In an implementation, system 108 will not apply protections for sensitive content items to unselected types 304 of sensitive content item that the user hosts with system 108. The user may use interface 300 from time to time to change the set of types 304 of sensitive content items that the user hosts with system 108 that the user wishes to have protected by system 108. Types 304 are just some examples of possible types of sensitive content items. In an implementation, interface 300 may allow the user to select a subset of types 304 or a superset thereof.

The sensitive content items that a user hosts with system 108 may contain different types of sensitive information items. For example, among the sensitive information items in the user's sensitive content items hosted with system 108, there may be one or more of the following types of sensitive information items in different categories of sensitive information items, or in a subset of these sensitive information item types:
financial sensitive information items (e.g., bank account number, bank routing number, credit card number, credit card cvv number, credit card expiration date, bank or credit card PIN code, etc.);
personal sensitive information items (e.g., name, home address, phone number, email address, age, date of birth, mother's maiden name, etc.);
information technology security sensitive information items (e.g., username, password, etc.); and
governmental sensitive information items (e.g., social security number, visa number, passport number, driver's license number, etc.)

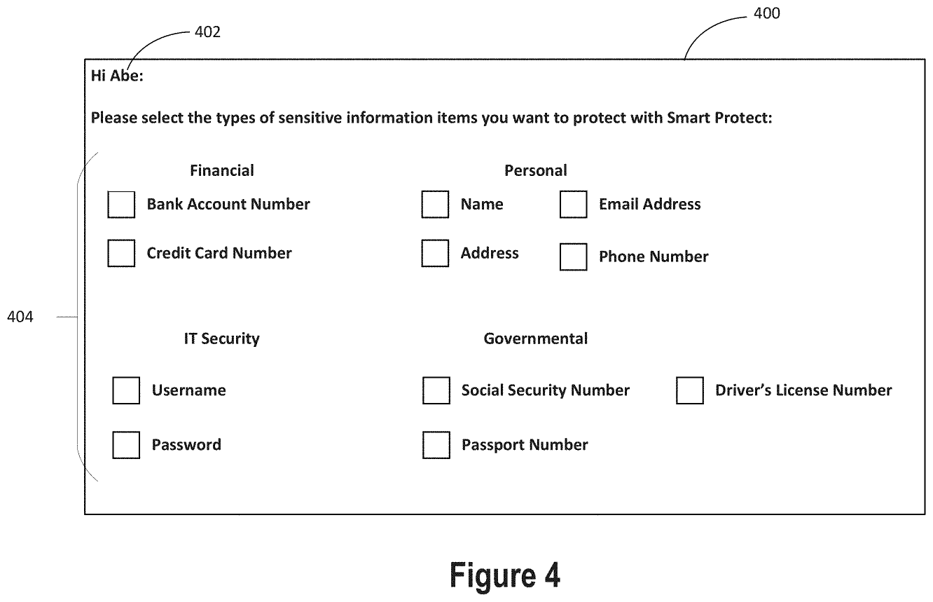

FIG. 4 is a mock-up of a possible graphical user interface 400 that allows a user of content management computing system 108 to select which types of sensitive information items should receive protections for sensitive content items. User interface module 112 may cause interface 400 to be presented at a client device 102 of the user in conjunction with a client application executing at the client device 102 such as a web browser application or other client application. Interface 400 provides an identity 402 of the user. In this example, types 404 of sensitive information items include financial sensitive information items, personal sensitive information items, information technology sensitive information items, and governmental sensitive information items. The financial sensitive information items include bank account number and credit card number. The personal sensitive information items include name, address, email address, and phone number. The information technology sensitive information items include username and password. The governmental sensitive information items include social security number, passport number, and driver's license number. The user may select one or more of sensitive information item types 404 to configure system 108 to apply protections to content items the user hosts with system 108 that contain any one of the selected types 404 of sensitive information items. In an implementation, system 108 will not apply protections for sensitive content items that the user hosts with system 108 that do not contain at least one of the selected types 404 of sensitive information items. The user may use interface 400 from time to time to change the set of types 404 of sensitive information items that the user wishes to have protected by system 108. Types 404 are just some examples of possible types of sensitive information items. In an implementation, interface 400 may allow the user to select a subset of types 404 or a superset thereof.

In an implementation, the user can select both sensitive content item types (e.g., via interface 300 of FIG. 3) and sensitive information item types (e.g., via interface 400 of FIG. 4). In that case, a sensitive content item that the user hosts with system 108 may received sensitive content item protections if the sensitive content item is either (i) one of the selected sensitive content item types or (ii) contains at least one of the selected sensitive information item types. In an alternative implementation, the sensitive content item receives content item protections only if the sensitive content item is both (i) one of the selected sensitive content item types and (ii) contains at least one of the selected sensitive information item types.

### Example Sensitive Content Item Protection Process

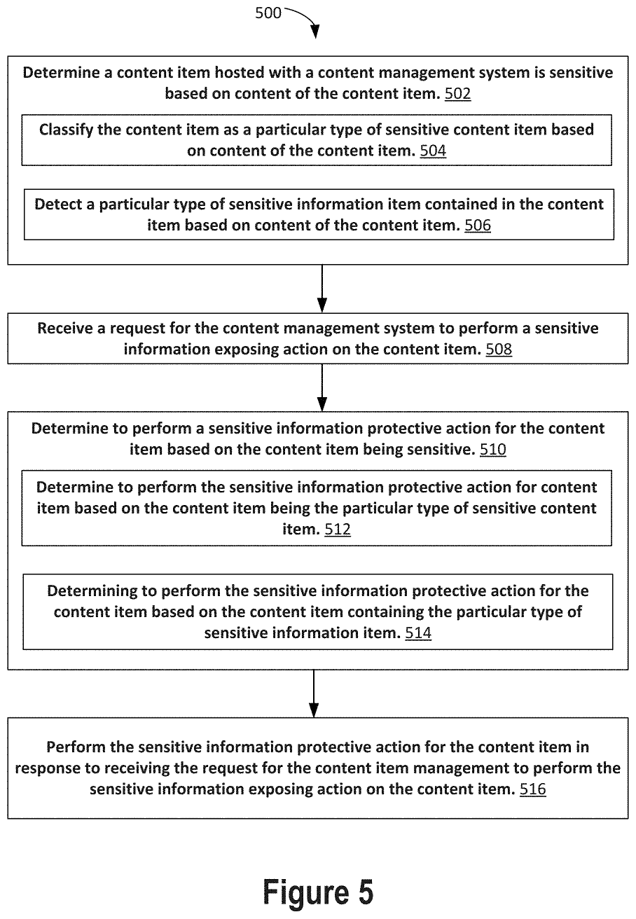

FIG. 5 includes flowchart 500 of a process for protecting a user of the content management system from inadvertently or accidentally disclosing sensitive information contained in a content item hosted with the system. The process begins with system 108 determining 502 that a content item hosted with system 108 is sensitive. System 108 makes the determination 502 based on content of the content item. In an implementation, as represented by block 504 nested within block 502, determining 502 that the content item is sensitive is based on classifying the content item as a particular type of sensitive content item based on content of the content item. In an implementation, as represented by block 506 nested within block 502, determining 502 that the content item is sensitive is based on detecting a particular type of sensitive information item contained in the content item based on content of the content item. In an implementation, as represented by blocks 504 and 506 nested within block 502, determining 502 that the content item is sensitive is based on both: (i) classifying the content item as a particular type of sensitive content item and (ii) detecting that the content item contains a particular type of sensitive information item.

The process continues with system 108 receiving 508 a request for system 108 to perform a sensitive information exposing action on the content item. For example, the sensitive information exposing action may be sharing the content item.

At block 510, system 108 determines 510 to perform a sensitive information protective action for the content item based on the system 108 having determined 502 that the content item is sensitive. In an implementation, as represented by block 512 nested within block 510, system 108 determines 510 to perform the sensitive information protective action for the content item based on system 108 having classified the content item as a particular type of sensitive content item. In an implementation, as represented by block 514 nested within block 510, system 108 determines 510 to perform the sensitive information protective action for the content item based on system 108 having detected that the content item contains a particular type of sensitive information item. In an implementation, as represented by blocks 512 and 514 nested within block 510, system 108 determines 510 to perform the sensitive information protective action for the content item based on system 108 having both classified the content item as a particular type of sensitive content item and detected the content item contains a particular type of sensitive information item.

At block 516, system 108 performs the sensitive information protective action for the content item in response to having received the request for system 108 to perform the sensitive information exposing action on the content item.

### Examples of Determining a Content Item is Sensitive

If a content item hosted with system 108 contains text content, then system 108 can determine that a content item hosted with system 108 is sensitive based on text content of the content item. In particular, system 108 can apply natural language processing (NLP) or deep language processing (DLP) techniques to text content of the content item to determine whether the content item is sensitive. This determination may be a statistical or probabilistic determination.

In an implementation, system 108 trains a set of binary classifiers in a supervised learning manner and uses the set of trained binary classifiers to determine whether a given content item containing text content is sensitive. Each of the binary classifiers may be a stochastic gradient descent binary classifier, for example. However, other types of machine learning-based binary classifiers may be used.

In an implementation, system 108 uses a different trained binary classifier for each different type of sensitive content item containing text content to which system 108 applies sensitive content item protections. For example, if system 108 applies sensitive content item protections for contractual, tax, medical, loan, and estate content items containing text content, then system 108 may train and use a separate binary classifier for each of these types of sensitive content items containing text content. In particular, system 108 may train a first binary classifier to distinguish between contractual content items and not contractual content items, a second binary classifier to distinguish between tax content items and not tax content items, a third binary classifier to distinguish between medical content items and not medical content items, and so on.

To determine whether a given content item is sensitive, system 108 may classify the given content item based on text content of the content item using each of the separate binary classifiers. Each of the binary classifiers may output a numerical value representing a probability that the given content item belongs to a respective sensitive content item class. For example, a first binary classifier may output a probability value indicating a probability that a given content item is a contractual content item or is not a contractual content item, the second classifier may output a probability value indicating a probability that the given content item is a tax content item or not a tax content item, a third classifier may output a probability value indicating a probability that the given content item is a medical content item or non a medical content item, and so on.

The given content item may be deemed sensitive by system 108 if at least one of the binary classifiers outputs a positive probability value indicating that the given content item belongs to the respective sensitive content item class. A positive probability value is a value above a threshold. For example, a binary classifier may output a value between 0 and 1 where 0 represents the lowest probability that the given content item belongs to the respective sensitive content item class and 1 represents the highest probability that the given content item belongs to the respective content item class. In this case, system 108 may deem the given content item to belong to the respective sensitive content item class if the value output by the classifier is greater than 0.5, for example. In other words, an output value greater than 0.5 may be considered by system 108 to be a positive probability value and an output value less than or equal to 0.5 may be considered by system 108 not to be a positive probability value. If none of the classifiers outputs a positive probability value for the given content item, then system 108 may deem the content item as not sensitive. Furthermore, when at least one classifier outputs a positive probability value for the given content item, then the given content item may be deemed to be the sensitive content item type corresponding to the highest positive probability value output by all the binary classifiers. For example, if the binary classifier for tax content item or not tax content item outputs the highest probability value for the given content item, then system 108 may deem the given content item as a tax sensitive content item as opposed to the other possible types of sensitive content items corresponding to the other binary classifiers.

The foregoing binary classifier scheme is just one possible way system 108 can determine if a given content item is sensitive. Another machine learning-based approach can be used. For example, instead of a set of binary classifiers, a single multiclass classifier can be used that is trained to distinguish between all different types of sensitive content items containing text content to which system 108 applies sensitive content item protections.

If the given content item is a digital photo or video, then system 108 may determine that the given content item is sensitive based on detecting a user in the photo or video. For example, system 108 may apply facial recognition technology to the photo or video frames of the video to detect a face of a user of system 108. If the face of the user is detected by system 108, then system 108 may determine that the given content item is sensitive with respect to that user. Furthermore, system 108 may determine that the given content item is sensitive based on text detected in the photo or a frame of the video. For example, system 108 applies Optical Character Recognition (OCR) to extract text from an image of the given content item. System 108 then determines whether the text from the image includes a sensitive information item or represents a particular type of sensitive content item as described in detail herein.

Another way system 108 can determine that a content item containing text content is sensitive is by detecting a sensitive information item in text content of the content item. Various techniques may be used to detect a sensitive information item in text content of a content item and no particular technique is required. A sensitive information item can be a name, email address, identification number, credit card number, or other type of sensitive information item. System 108 may scan a content item hosted with system 108 to determine if it contains a textual sensitive information item. In doing so, system 108 may scan for a predetermined type of textual sensitive information item such as a name, email address, identification number, credit card number, or other type of textual sensitive information item.

System 108 may employ a variety of techniques during a scan of a content item to discover and probabilistically classify a textual sensitive information item contained in text content of the content item. For example, the scan techniques may be based on pattern matching (e.g., regular expressions), mathematical checksums, digit restrictions, specific prefixes, or surrounding context. For example, the text “SSN 222-22-2222” in text content of a content item may be detected by system 108 as probably a sensitive information item. In particular, system 108 may detect this text as probably a United States social security number based on the text being in the standard social security number format and based on the nearby context “SSN.” At the same time, system 108 may detect the text “999-98-9999” as probably not a social security number even though the text is in the standard social security number format because a valid social security number cannot start with a 9 and there is no nearby context indicating the text represents a social security number. However, system 108 may detect the same text as probably a valid United States taxpayer identification number.

### Sensitive Information Exposing Action Examples

An example of a sensitive information exposing action is sharing a sensitive content item in content management system 100.

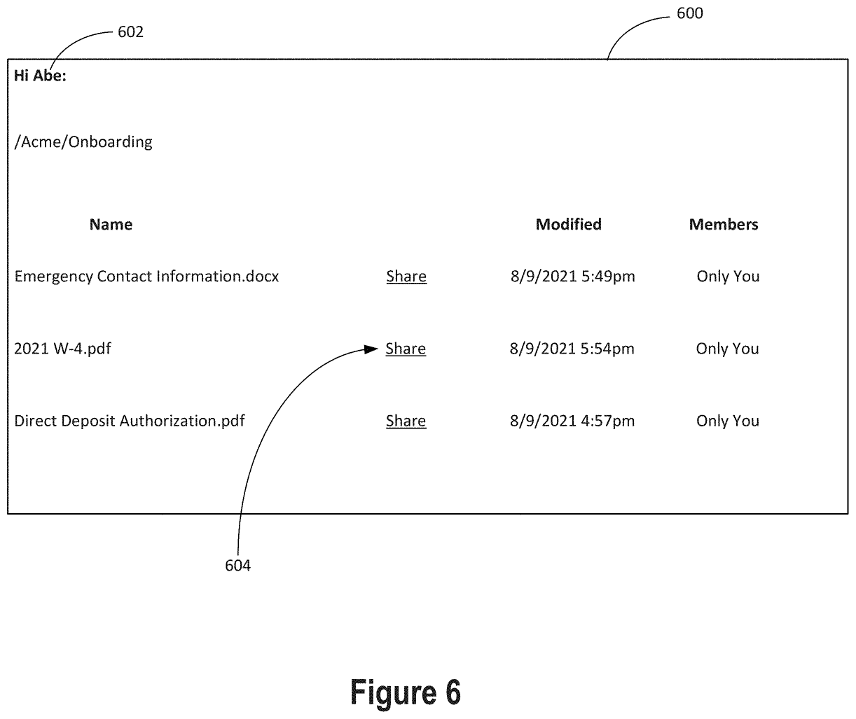

FIG. 6 is a mock-up of possible graphical user interface 600 allowing a user to request the content management system to perform a sensitive information exposing action on a sensitive content item. User interface module 112 may cause interface 600 to be presented at a client device 102 of the user in conjunction with a client application executing at the client device 102 such as a web browser application or other client application. Interface 600 provides an identity 602 of the user. Interface 600 also provides a listing of content items hosted with system 108 and logically contained in a particular location within a content item hierarchy as indicated by the path “/Acme/Onboarding.” In this example, there are three content items logically contained in the particular location.

Each content item in the listing is indicated by a name (e.g., a filename), a last modified date and time, and membership information. Membership information indicates which users of system 108 have access in system 108 to the respective content item. In this example, only Abe has access to the three content items and none of the content items are currently shared with other users of system 108. Each content item in the listing is also associated with graphical user interface controls for sharing the respective content item. For example, the “2021 W-4.pdf” content item is associated with graphical user interface controls 604 for sharing that content item. In this example and the following examples, it is assumed that the “2021 W-4.pdf” content item is determined by system 108 to be a sensitive content item. For example, system 108 may classify the content item as a tax content item or system 108 may detect a sensitive information item such as a United States social security number in text content of the content item. By activating controls 604, the user (Abe) can request system 108 to perform the sensitive information exposing action of sharing the “2021 W-4.pdf” content item.

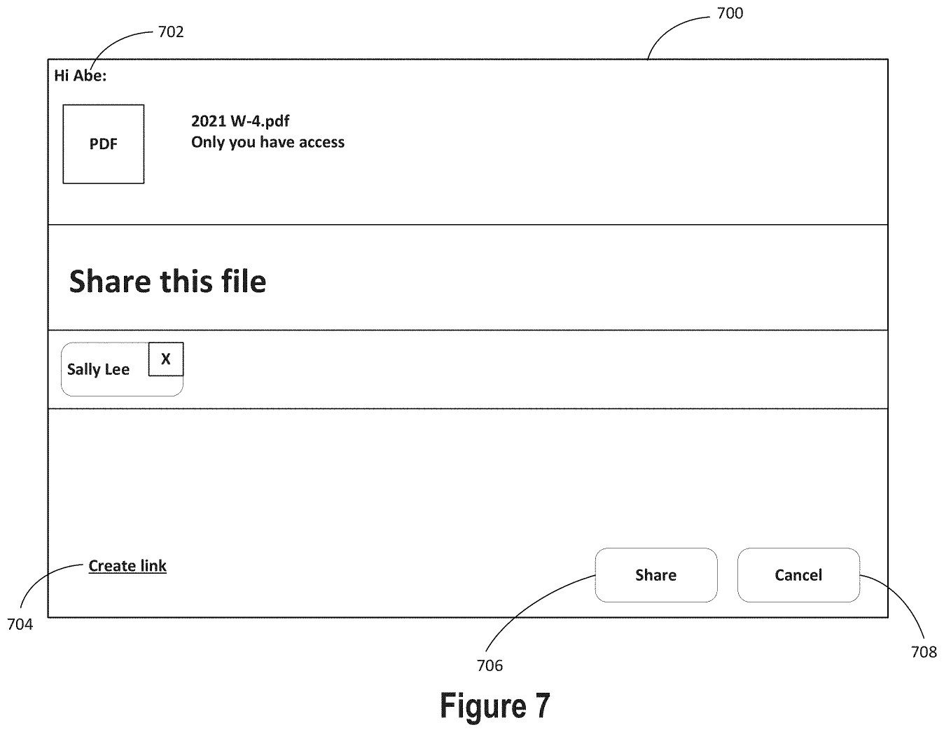

FIG. 7 is a mock-up of possible graphical user interface 700 allowing a user to request the content management system to perform a sensitive information exposing action on a sensitive content item. User interface module 112 may cause interface 700 to be presented at a client device 102 of the user in conjunction with a client application executing at the client device 102 such as a web browser application or other client application. In an implementation, interface 700 is displayed in response to the user activating sharing controls 604 for the “2021 W-4.pdf” sensitive content item in interface 600. Interface 700 provides an identity 702 of the user. Interface 700 is for sharing the selected sensitive content item. In this example, the user has selected an intended invited user named “Sally Lee.” Interface 700 provides graphical user interface controls 704 for sharing the sensitive content item as a unique link (e.g., a unique Uniform Resource Locator (URL)) that is created in response to activating controls 704. The unique link can be provided to the invited user in an email message, a text message, or posted on a web page.

In an implementation, the created unique link is private or closed (not public) in the sense that only the sharing user and an invited user (in this example “Sally Lee”) can use the unique link to access the sensitive content item from system 108 and a user in possession of the unique link that is not the sharing user or an invited user cannot use the unique link to access the sensitive content item from system 108.

Interface 700 also provides graphical user interface controls 706 for sharing the sensitive content item with the invited user. By activating controls 706, system 108 grants the invited user (in this example “Sally Lee”) permission to access the sensitive content item from system 108. For example, system 108 may automatically synchronize the sensitive content item to the invited user's client devices connected to system 108 and allow the invited user to access (e.g., view, edit, or download) the sensitive content from system 108 at a client device 102 using a client application executing at the client device 102 such as a web browser application or other client application. Interface 700 also provides graphical user interface controls 708 for canceling the current sharing operation. The sharing user activating controls 704 or 706 are examples of requesting system 108 to perform a sensitive information exposing action on a sensitive content item.

### Sensitive Information Protective Action Examples

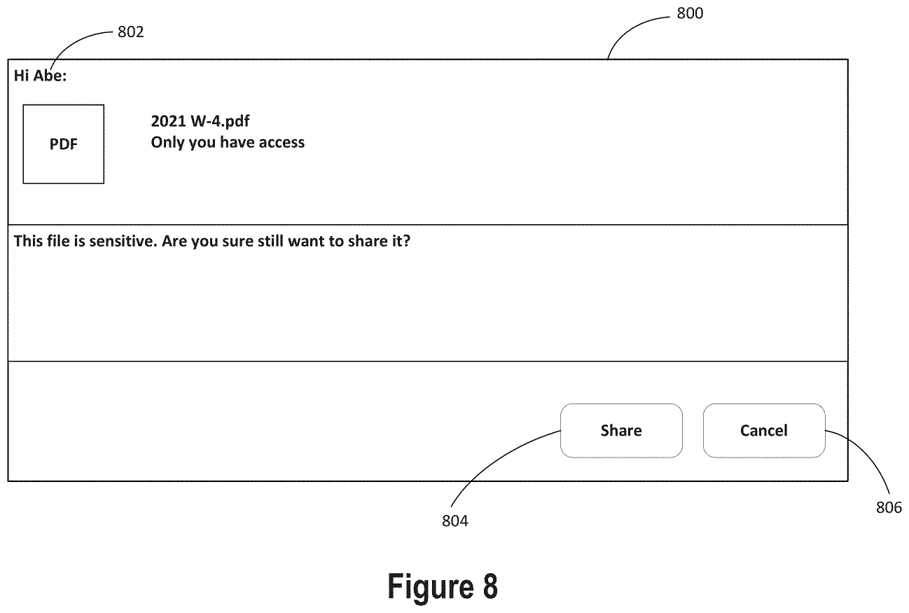

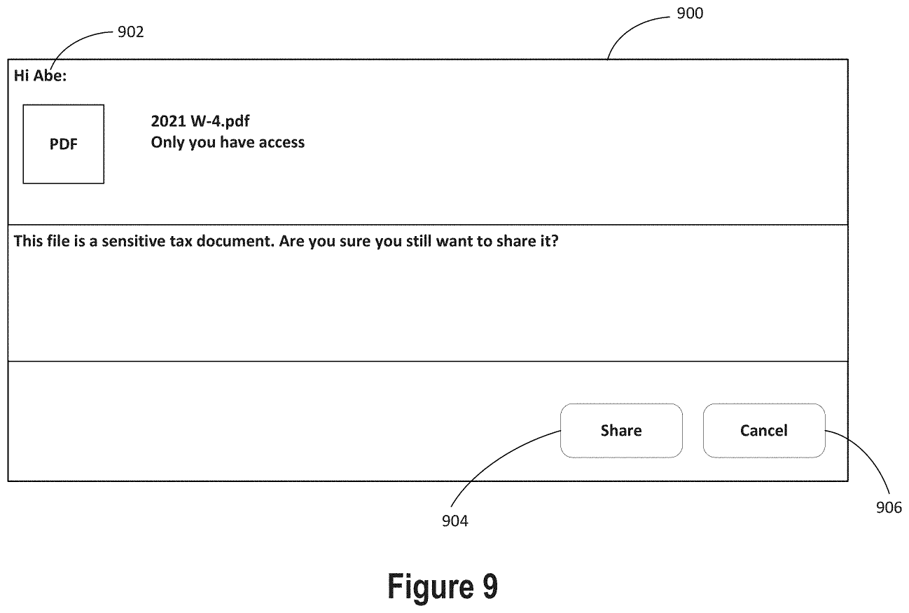

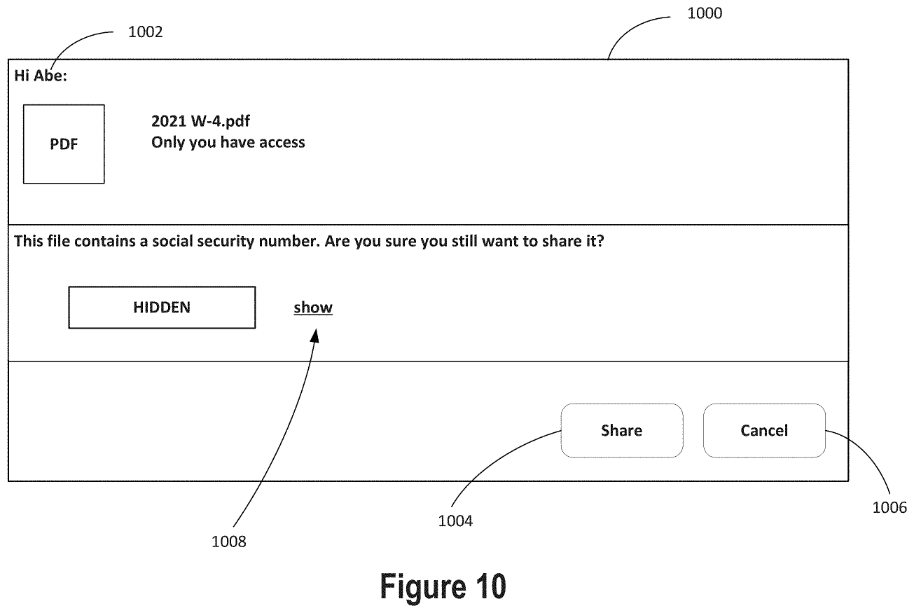

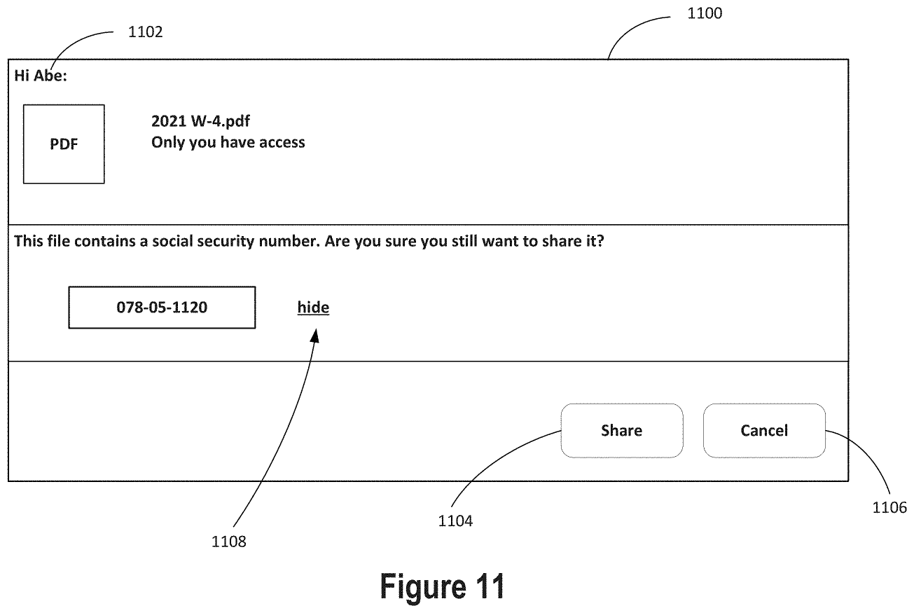

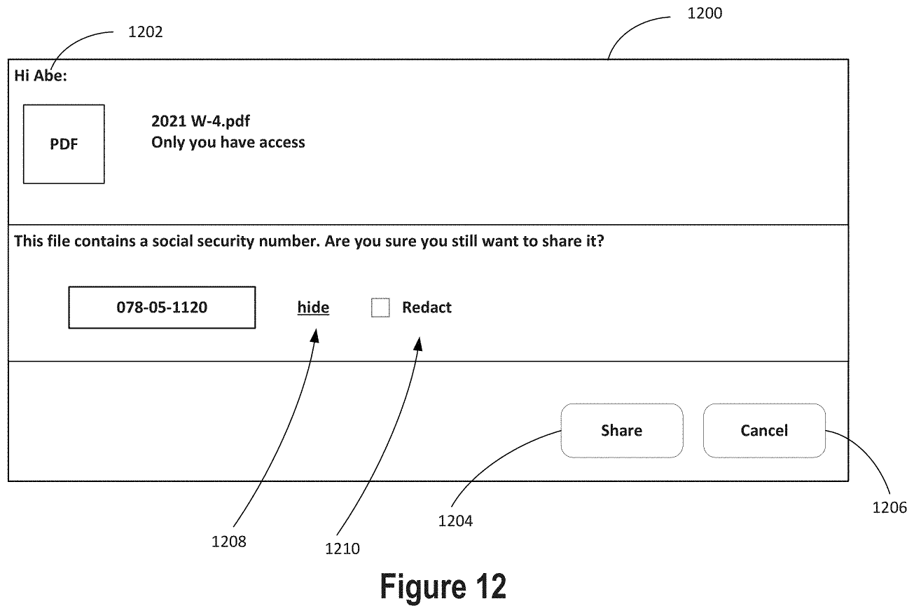

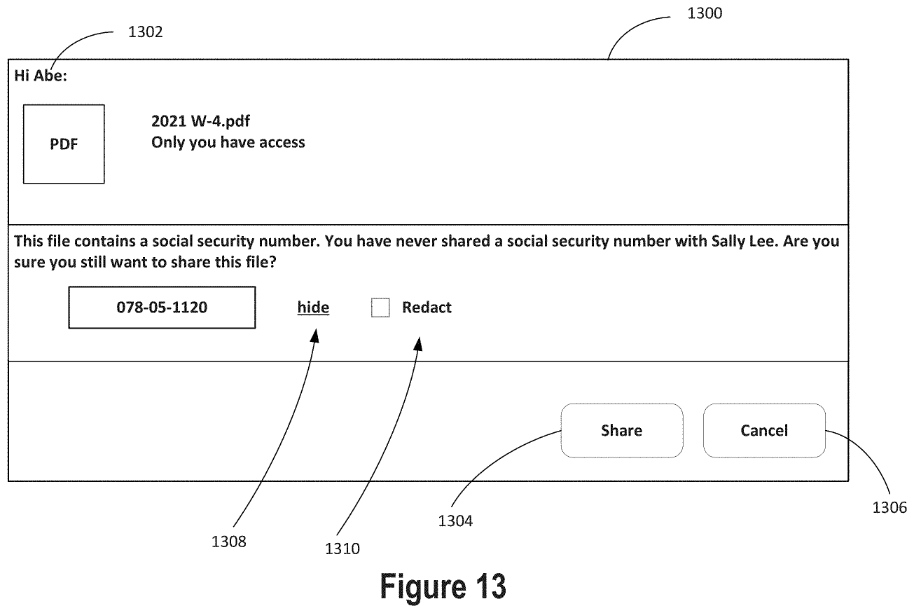

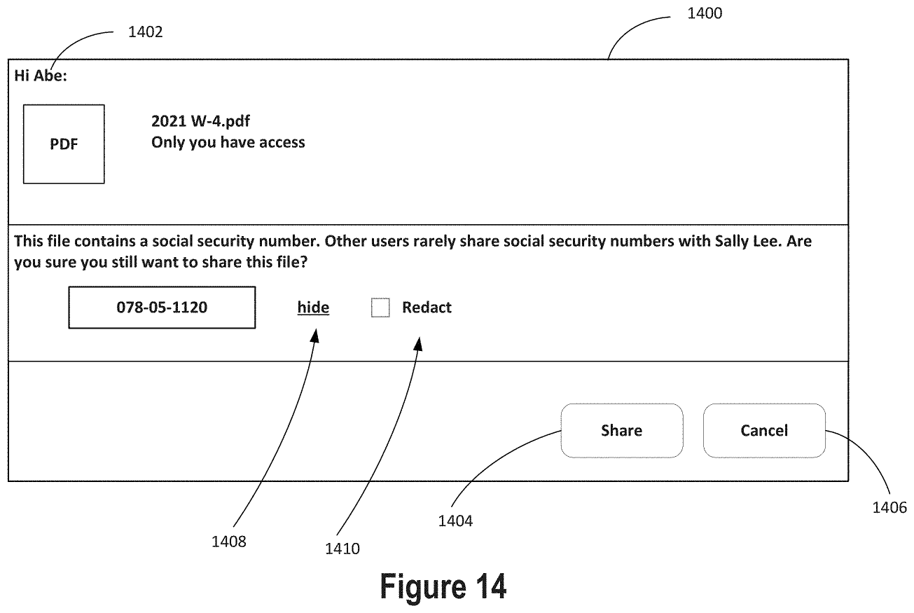

Continuing the example of FIG. 6 and FIG. 7, some examples of sensitive information protective actions performed by system 108 will now be described with respect to FIG. 8, FIG. 9, FIG. 10, FIG. 11, FIG. 12, FIG. 13, and FIG. 14.

FIG. 8 is a mock-up of possible graphical user interface 800 depicting a sensitive information protective action performed by the content management system for a sensitive content item. User interface module 112 may cause interface 800 to be presented at a client device 102 of the user in conjunction with a client application executing at the client device 102 such as a web browser application or other client application. In an implementation, interface 800 is displayed at the client device 102 in response to activation of controls 604, 704, or 706. Interface 800 indicates 802 the sharing user. Interface 900 also indicates to the sharing user that the sensitive content item is sensitive. Interface 800 also prompts the sharing user to confirm sharing of the sensitive content item. The sharing user can activate graphical user interface controls 804 to proceed with the sharing operation. Alternatively, the sharing user can activate graphical user interface controls 806 to cancel the sharing operation.

FIG. 9 is a mock-up of possible graphical user interface 900 depicting a sensitive information protective action performed by the content management system for a sensitive content item. User interface module 112 may cause interface 900 to be presented at a client device 102 of the user in conjunction with a client application executing at the client device 102 such as a web browser application or other client application. In an implementation, interface 900 is displayed at the client device 102 in response to activation of controls 604, 704, or 706. Interface 900 indicates 902 the sharing user. Interface 900 also indicates to the sharing user that the sensitive content item is sensitive. In addition, interface 900 indicates why system 108 has determined the content item to be sensitive. In this example, system 108 has determined the content item to be sensitive because the content item has been classified as a tax content item. Interface 900 also prompts the sharing user to confirm sharing of the sensitive content item. The sharing user can activate graphical user interface controls 904 to proceed with the sharing operation. Alternatively, the sharing user can activate graphical user interface controls 906 to cancel the sharing operation.

FIG. 10 is a mock-up of possible graphical user interface 1000 depicting a sensitive information protective action performed by the content management system for a sensitive content item. User interface module 112 may cause interface 1000 to be presented at a client device 102 of the user in conjunction with a client application executing at the client device 102 such as a web browser application or other client application. In an implementation, interface 1000 is displayed at the client device 102 in response to activation of controls 604, 704, or 706. Interface 1000 indicates 1002 the sharing user. Interface 1000 also indicates to the sharing user that the sensitive content item is sensitive. In addition, interface 1000 indicates why system 108 has determined the content item to be sensitive. In this example, system 108 has detected that the content item contains a sensitive information item in the form of a United States social security number. Interface 1000 provides graphical user interface controls 1008 for revealing the social security number that is detected by system 108 as a sensitive information item. Interface 1000 also prompts the sharing user to confirm sharing of the sensitive content item. The sharing user can activate graphical user interface controls 1004 to proceed with the sharing operation. Alternatively, the sharing user can activate graphical user interface controls 1006 to cancel the sharing operation.

FIG. 11 is a mock-up of possible graphical user interface 1100 depicting a sensitive information protective action performed by the content management system for a sensitive content item. User interface module 112 may cause interface 1000 to be presented at a client device 102 of the user in conjunction with a client application executing at the client device 102 such as a web browser application or other client application. In an implementation, interface 1100 is displayed at the client device 102 in response to activation of controls 1008 of FIG. 10. In response to activation of controls 1008 of FIG. 10, the social security number that is hidden in interface 1000 of FIG. 10 is revealed in interface 1100. In this example, the social security number is an invalid “pocketbook” social security number provided for purposes of illustration only. The sharing user can activate graphical user interface controls 1108 to hide the sensitive information item again. Interface 1100 also prompts the sharing user to confirm sharing of the sensitive content item. The sharing user can activate graphical user interface controls 1104 to proceed with the sharing operation. Alternatively, the sharing user can activate graphical user interface controls 1106 to cancel the sharing operation.

FIG. 12 is a mock-up of possible graphical user interface 1200 depicting a sensitive information protective action performed by the content management system for a sensitive content item. User interface module 112 may cause interface 1000 to be presented at a client device 102 of the user in conjunction with a client application executing at the client device 102 such as a web browser application or other client application. In an implementation, interface 1200 is displayed at the client device 102 in response to activation of controls 1008 of FIG. 10. In response to activation of controls 1008 of FIG. 10, the social security number that is hidden in interface 1000 of FIG. 10 is revealed in interface 1200. In addition, interface 1200 provides a checkbox that the sharing user can activate to redact the sensitive information item (in this example a social security number) from a copy of the sensitive content item that is shared with the invited user. Interface 1200 also prompts the sharing user to confirm sharing of the sensitive content item. The sharing user can activate graphical user interface controls 1204 to proceed with the sharing operation. If checkbox 1210 is selected, then system 108 creates a copy of the sensitive content item without the social security number and shares the copy with the invited user. If checkbox 1210 is not selected, then system 108 shares the sensitive content item containing the social security number with the invited user. The sharing user can also activate graphical user interface controls 1206 to cancel the sharing operation.

System 108 redacting a sensitive information item from a copy of a sensitive content item can be accomplished in various ways. In one way, system 108 removes or deletes the data representing the sensitive information item from the copy of the sensitive content item created. In another way, system 108 encrypts or obfuscates the sensitive information item in the copy of the sensitive content item created. If the sensitive content item is a photo of the sharing user, then system 108 may process the photo to blur or cover the area of the photo where the sharing user's face appears.

FIG. 13 is a mock-up of possible graphical user interface 1300 depicting a sensitive information protective action performed by the content management system for a sensitive content item. In this example, system 108 maintains an “outbound” sharing history of content items shared by the sharing user with other users of system 108. For each content item the sharing user has shared, system 108 may record (e.g., in user account database 128) an identifier of the content item shared, whether the content item shared was determined by system 108 to be sensitive and if the content item was determined by system 108 to be sensitive, the type of sensitive content item and the type or types of sensitive information items contained in the sensitive content item. In addition, system 108 may record an invited user that the content item was shared with.

User interface module 112 may cause interface 1300 to be presented at a client device 102 of the sharing user in conjunction with a client application executing at the client device 102 such as a web browser application or other client application. In an implementation, interface 1300 is displayed at the client device 102 in response to activation of controls 604, 704, or 706. However, interface 1300 may also be displayed at the client device 102 in response to activation of controls 1008 of FIG. 10. Based on the outbound sharing history of the sharing user, system 108 has determined that the sharing user has never shared a sensitive content item containing a social security number with the invited user. Interface 1300 indicates this. Interface 1300 also prompts the sharing user to confirm sharing of the sensitive content item. The sharing user can activate graphical user interface controls 1304 to proceed with the sharing operation. Alternatively, the sharing user can activate graphical user interface controls 1306 to cancel the sharing operation.

FIG. 14 is a mock-up of possible graphical user interface 1400 depicting a sensitive information protective action performed by the content management system for a sensitive content item. In this example, system 108 maintains an “inbound” sharing history of content items shared with the invited user by other users of system 108. For each content item that has been shared with the invited used, system 108 may record (e.g., in user account database 128) an identifier of the content item shared, whether the content item shared was determined by system 108 to be sensitive and if the content item was determined by system 108 to be sensitive, the type of sensitive content item and the type or types of sensitive information items contained in the sensitive content item.

User interface module 112 may cause interface 1400 to be presented at a client device 102 of the sharing user in conjunction with a client application executing at the client device 102 such as a web browser application or other client application. In an implementation, interface 1400 is displayed at the client device 102 in response to activation of controls 604, 704, or 706. However, interface 1400 may also be displayed at the client device 102 in response to activation of controls 1008 of FIG. 10. Based on the inbound sharing history of the invited user, system 108 has determined that users of system 108 rarely (e.g., never or below a threshold number of times) share sensitive content items containing a social security number with the invited user. Interface 1400 indicates this. Interface 1400 also prompts the sharing user to confirm sharing of the sensitive content item. The sharing user can activate graphical user interface controls 1404 to proceed with the sharing operation. Alternatively, the sharing user can activate graphical user interface controls 1406 to cancel the sharing operation.

### Example Computing Device

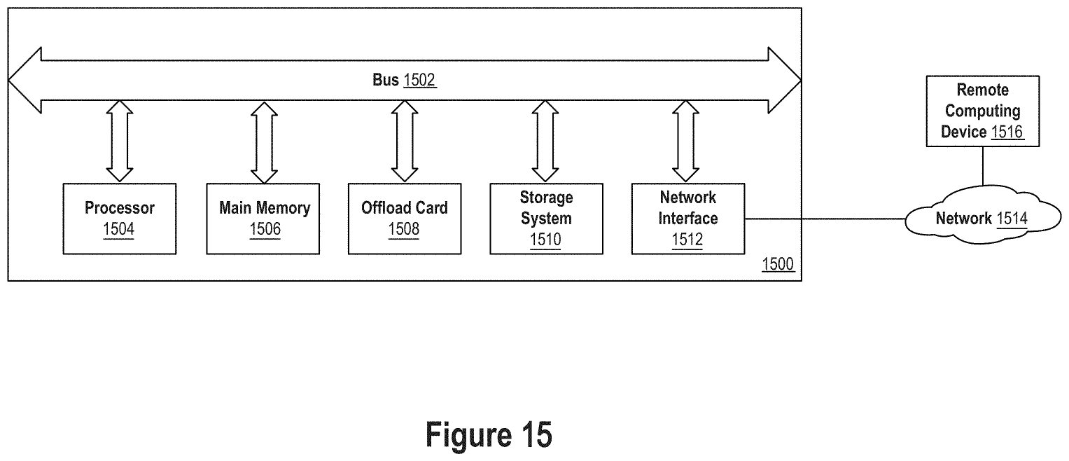

A computing system that implements the disclosed techniques for smart sharing of sensitive content items in a content management system may include a general-purpose computing device that includes or is configured to access one or more computer-accessible media, such as computing device 1500 illustrated in FIG. 15. Computing device —00 includes processor 1504 coupled to system or main memory 1506 via an input/output (I/O) interface or bus 1502. Computing device 1500 further includes network interface 1512 coupled to bus 1502. While FIG. 15 shows computing device 1500 as a single computing device, in various embodiments a computing system may include one computing device or any number of computing devices configured to work together as a single computing system.

Computing device 1500 may be a uniprocessor system including one processor 1504, or a multiprocessor system including multiple processors 1504 (e.g., two, four, eight, or another suitable number). Processor 1504 may be any suitable processor capable of executing computer program instructions. For example, processor 1504 may be general-purpose or embedded processor implementing any of a variety of instruction set architectures (ISAs), such as the x86, ARM, PowerPC, SPARC, or MIPS ISAs, or any other suitable ISA. In a multiprocessor computing device 1500, each of processors 1504 may commonly, but not necessarily, implement the same ISA.

Main memory 1506 may store computer program instructions and data accessible by processor 1504. Main memory 1506 may be implemented using any suitable memory technology, such as random-access memory (RAM), static RAM (SRAM), synchronous dynamic RAM (SDRAM), nonvolatile or Flash-type memory, or any other type of memory. Computer program instructions implementing one or more desired functions, such as the methods and techniques disclosed herein may be stored within main memory 1506. Computer program instructions stored in main memory 1506 can be source code, object code, bytecode, machine code, microcode, or other type of computer program instructions that are executable by processor 1504. As part of executing computer program instructions stored in main memory 1506, the computer program instructions may be in a directly executable form (e.g., machine code or microcode) or processor 1504 may translate the computer program instructions in a higher-level executable form (e.g., source code, object code, or bytecode) to a lower-level executable form (e.g., machine code or microcode), possibly through one or more intermediate executable forms, at the direction of a translator such as a compiler, an interpreter, or an assembler.

Bus 1502 may be configured to coordinate I/O traffic between processor 1504, main memory —06, and any peripheral devices in the device, including network interface 1512 or other peripheral interfaces. Bus 1502 may perform any necessary protocol, timing, or other data transformations to convert data signals from one component (e.g., main memory 1506) into a format suitable for use by another component (e.g., processor 1504). Bus 1502 may include support for devices attached through various types of peripheral buses, such as a variant of the Peripheral Component Interconnect (PCI) bus standard or the Universal Serial Bus (USB) standard, for example. The function of bus 1502 may be split into two or more separate components, such as a north bridge and a south bridge, for example. Some or all the functionality of bus 1502, such as an interface to main memory 1506, may be incorporated directly into processor 1504.

Network interface 1512 may be configured to allow data to be exchanged between computing device 1500 and another device 1516 attached to data communications network 1514. Network interface 1512 may support communication via any suitable wired or wireless data communications networks, such as an Ethernet network, a Wireless Local Area Network, a cellular phone network, a Bluetooth wireless network, a storage area network, or via any other suitable type of data communications network.

Computing device 1500 may include offload card 1508. Offload card 1508 itself may include a processor and a network interface that are connected using bus 1502 (e.g., a bus implementing a version of the Peripheral Component Interconnect-Express (PCI-E) standard, or another interconnect such as a QuickPath interconnect (QPI) or UltraPath interconnect (UPI)). For example, computing device 1500 may act as a host electronic device (e.g., operating as part of a hardware virtualization service) that hosts compute instances. In this configuration, offload card 1508 may execute a virtualization manager that can manage compute instances that execute on the host electronic device. For example, offload card 1508 can perform compute instance management operations such as pausing or un-pausing compute instances, launching or terminating compute instances, performing memory transfer or copying operations, etc. These management operations may be performed by offload card 1508 in coordination with a hypervisor (e.g., upon a request from a hypervisor) that is executed by processor 1504 of computing device 1500. However, the virtualization manager implemented by offload card 1508 can accommodate requests from other entities (e.g., from compute instances themselves), and may not coordinate with or provide service to any separate hypervisor.

Main memory 1506 is one example a non-transitory computer-readable medium for storing computer program instructions and data. Another example of a non-transitory computer-readable medium for storing computer program instructions and data for processor 1502 is mass storage system 1510 coupled to bus 1502. Mass storage system 1510 can take various forms including non-volatile RAM (NVRAM), solid-state drive, hard disk, flash drive, optical disk, or other suitable type of mass storage system. Non-transitory computer-readable media such as main memory 1506 and mass storage system 1510 are distinct from, but may be used in conjunction with, transmission media. Transmission media participates in transferring information between non-transitory computer-readable media. For example, transmission media includes coaxial cables, copper wire and fiber optics, including the wires that comprise bus 1502. Transmission media can also take the form of acoustic or light waves, such as those generated during radio-wave and infra-red data communications.

### Terminology

Unless the context clearly indicates otherwise, the term “or” is used in the specification and in the appended claims in its inclusive sense (and not in its exclusive sense) so that when used, for example, to connect a list of elements, the term “or” means one, some, or all the elements in the list.

Unless the context clearly indicates otherwise, the terms “comprising,” “including,” “having,” “based on,” “encompassing,” and the like, are used in the specification and in the appended claims in an open-ended fashion, and do not exclude additional elements, features, acts, or operations.

Unless the context clearly indicates otherwise, conjunctive language such as the phrase “at least one of X, Y, and Z,” is to be understood to convey that an item, term, etc. may be either X, Y, or Z, or a combination thereof. Thus, such conjunctive language is not intended to require by default implication that at least one of X, at least one of Y and at least one of Z to each be present.

Unless the context clearly indicates otherwise, as used in the specification description and in the appended claims, the singular forms “a,” “an,” and “the” are intended to include the plural forms as well.

Unless the context clearly indicates otherwise, in the specification and in the appended claims, although the terms first, second, etc. are, in some instances, used herein to describe various elements, these elements should not be limited by these terms. These terms are only used to distinguish one element from another. For example, a first computing device could be termed a second computing device, and, similarly, a second computing device could be termed a first computing device. The first computing device and the second computing device are both computing devices, but they are not the same computing device.

Reference in the specification to “an implementation of the disclosed techniques”, “one implementation of the disclosed techniques,” and the like, are not intended to be exclusive of other implementations of the disclosed techniques, unless the context clearly indicates otherwise or one skilled in the art, based on this disclosure, would understand the implementations to be incompatible.

Unless the context clearly indicates otherwise, the phrase “an implementation of the disclosed techniques,” “one implementation of the disclosed techniques,” and the like, refers to the corresponding described implementation that is constructively reduced to practice by this disclosure. The implementation may or may not have been actually reduced to practice.

In the foregoing specification, the disclosed techniques have been described with reference to numerous specific details that may vary from implementation to implementation. The specification and drawings are, accordingly, to be regarded in an illustrative rather than a restrictive sense.

1. A method comprising:
based on content of a content item hosted with a content management system, determining that the content item is sensitive;
receiving a request for the content management system to perform a sensitive information exposing action on the content item;
based on the content item being sensitive, determining to perform a sensitive information protective action for the content item;
in response to receiving the request for the content management system to perform the sensitive information exposing action on the content item, performing the sensitive information protective action for the content item; and
wherein the method is performed by one or more processors.

2. The method of claim 1, wherein:
said determining that the content item is sensitive comprises classifying the content item as a particular type of sensitive content item based on the content of the content item; and
said determining to perform the sensitive information protective action for the content item is based on the content item being the particular type of sensitive content item.

3. The method of claim 1, wherein:
said determining that the content item is sensitive comprises detecting, based on the content of the content item, a particular type of sensitive information item contained in the content item; and
said determining to perform the sensitive information protective action for the content item is based on the content item containing the particular type of sensitive information item.

4. The method of claim 1, wherein:
said determining that the content item is sensitive comprises, based on the content of the content item:
classifying the content item as a particular type of sensitive content item, and
detecting a particular type of sensitive information item contained in the content item; and
said determining to perform the sensitive information protective action for the content item is based on the content item being the particular type of sensitive content item and based on the content item containing the particular type of sensitive information item.

5. The method of claim 1, wherein:
the sensitive information exposing action on the content item comprises sharing the content item; and
the sensitive information protective action performed for the content item comprises prompting to confirm sharing of the content item in a graphical user interface, the graphical user interface indicating that the content item is sensitive.

6. The method of claim 1, wherein:
the sensitive information exposing action on the content item comprises sharing the content item; and
the sensitive information protective action performed for the content item comprises prompting to confirm sharing of the content item in a graphical user interface, the graphical user interface indicating a particular type of sensitive content item identified for the content item.

7. The method of claim 1, wherein:
the sensitive information exposing action on the content item comprises sharing the content item; and
the sensitive information protective action performed for the content item comprises prompting to confirm sharing of the content item in a graphical user interface, the graphical user interface indicating a particular type of sensitive information item contained in the content item.

8. One or more non-transitory computer-readable media storing computer program instructions which, when executed by one or more processors, cause:
based on content of a content item hosted with a content management system, classifying the content item as a particular type of sensitive content item;
receiving a request for the content management system to perform a sensitive information exposing action on the content item;
based on the content item being the particular type of sensitive content item, determining to perform a sensitive information protective action for the content item; and
in response to receiving the request for the content management system to perform the sensitive information exposing action on the content item, performing the sensitive information protective action for the content item.

9. The one or more non-transitory computer-readable media of claim 8, further storing computer program instructions which, when executed by one or more processors, cause:
wherein the sensitive information exposing action on the content item comprises a sharing user sharing the content item with an invited user;
determining, based on an outbound sharing history of the sharing user, that the sharing user has not shared the particular type of sensitive content item with the invited user; and
wherein the sensitive information protective action performed for the content item comprises prompting to confirm sharing of the content item in a graphical user interface, the graphical user interface indicating that the sharing user has not shared the particular type of sensitive content item with the invited user.

10. The one or more non-transitory computer-readable media of claim 8, further storing computer program instructions which, when executed by one or more processors, cause:
determining, based on an inbound sharing history of an invited user, that the particular type of sensitive content item has not been shared with the invited user; and
wherein:
the sensitive information exposing action on the content item comprises sharing the content item; and
the sensitive information protective action performed for the content item comprises prompting a sharing user to confirm sharing of the content item in a graphical user interface, the graphical user interface indicating that the particular type of sensitive content item has not been shared with the invited user.

11. The one or more non-transitory computer-readable media of claim 8, wherein the particular type of sensitive content item is one of: digital photo content item, contractual content item, tax content item, medical content item, loan content item, and estate content item.

12. The one or more non-transitory computer-readable media of claim 8, wherein:
said determining that the content item is sensitive further comprises, based on the content of the content item, detecting a sensitive information item contained in the content item;
the sensitive information exposing action on the content item comprises sharing the content item;
the sensitive information protective action performed for the content item comprises:
displaying a graphical user interface providing one or more graphical user interface controls for redacting the sensitive information item in the content item, and
responsive to activation of a graphical user interface control, causing a redacted copy of the content item to be shared with an invited user, the sensitive information item being redacted from the redacted copy.

13. A computing system comprising:
one or more processors;
one or more non-transitory computer-readable media; and
computer program instructions stored in the one or more non-transitory computer-readable media and which, when executed by the one or more processors, cause:
based on content of a content item hosted with a content management system, detecting a sensitive information item contained in the content item;
receiving a request for the content management system to perform a sensitive information exposing action on the content item;
based on the content item containing the sensitive information item, determining to perform a sensitive information protective action for the content item; and
in response to receiving the request for the content management system to perform the sensitive information exposing action on the content item, performing the sensitive information protective action for the content item.

14. The computing system of claim 13, wherein the sensitive information protective action performed for the content item comprises:
displaying a graphical user interface providing one or more graphical user interface controls for displaying the sensitive information item from the content item; and
responsive to activation of a graphical user interface control, displaying, in the graphical user interface, the sensitive information item from the content item.

15. The computing system of claim 13, wherein:
the sensitive information exposing action on the content item comprises sharing the content item; and
the sensitive information protective action performed for the content item comprises:
displaying a graphical user interface providing one or more graphical user interface controls for redacting the sensitive information item in the content item, and
responsive to activation of a graphical user interface control, causing a redacted copy of the content item to be shared with an invited user, the sensitive information item being redacted from the redacted copy.

16. The computing system of claim 13, wherein the sensitive information item is of a particular type of sensitive information item, the system further comprising computer program instructions stored in the one or more non-transitory computer-readable media and which, when executed by the one or more processors, cause:
determining, based on an outbound sharing history of a sharing user, that the sharing user has not shared the particular type of sensitive information item with an invited user;
wherein the sensitive information exposing action on the content item comprises sharing the content item; and
wherein the sensitive information protective action performed for the content item comprises prompting the sharing user to confirm sharing of the content item in a graphical user interface, the graphical user interface indicating that the sharing user has not shared the particular type of sensitive information item with the invited user.

17. The computing system of claim 13, wherein the sensitive information item is of a particular type of sensitive information item, the system further comprising computer program instructions stored in the one or more non-transitory computer-readable media and which, when executed by the one or more processors, cause:
determining, based on an inbound sharing history of an invited user, that the particular type of sensitive information item has not been shared with the invited user;
wherein the sensitive information exposing action on the content item comprises sharing the content item; and
wherein the sensitive information protective action performed for the content item comprises prompting a sharing user to confirm sharing of the content item in a graphical user interface, the graphical user interface indicating that the particular type of sensitive information item has not been shared with the invited user.

18. The computing system of claim 13, wherein the sensitive information item is of a particular type of sensitive information item, the system further comprising computer program instructions stored in the one or more non-transitory computer-readable media and which, when executed by the one or more processors, cause:
determining, based on an inbound sharing history of an invited user, that the particular type of sensitive information item has rarely been shared with the invited user;
wherein the sensitive information exposing action on the content item comprises sharing the content item; and
wherein the sensitive information protective action performed for the content item comprises prompting a sharing user to confirm sharing of the content item in a graphical user interface, the graphical user interface indicating that the particular type of sensitive information item has rarely been shared with the invited user.

19. The computing system of claim 13, wherein the sensitive information item is of a particular type of sensitive information item, the particular type of sensitive information item being one of: bank account number, credit card number, name, address, email address, phone number, username, password, social security number, passport number, and driver's license number.

20. The computing system of claim 13, further comprising computer program instructions stored in the one or more non-transitory computer-readable media and which, when executed by the one or more processors, cause:
causing a graphical user interface to be displayed at a client device of a sharing user, the graphical user interface providing one or more graphical user interface controls for sharing the content item; and
receiving the request for the content management system to perform the sensitive information exposing action on the content item in response to an activation of a graphical user interface control for sharing the content item.
